(19) United States
(12) Patent Application Publication
(10) Pub. No.: US 2010/0228726 A1
(43) Pub. Date: Sep. 9, 2010

(54) DETERMINING ASSOCIATIVE INTENT IN A DATABASE CONTAINING LINKED ENTITIES

(76) Inventors: Scott W. Slinker, San Jose, CA (US); Anthony A. Shah-Nazaroff, Santa Clara, CA (US); James T. Brady, San Jose, CA (US)

Correspondence Address: SCHWEGMAN, LUNDBERG & WOESSNER, P.A., P.O. BOX 2938, MINNEAPOLIS, MN, 55402, US

(21) Appl. No.: 12/701,537

(22) Filed: Feb. 6, 2010

Related U.S. Application Data
(60) Provisional application No. 61/150,615, filed on Feb. 6, 2009.
(60) Provisional application No. 61/295,158, filed on Jan. 14, 2010.

(51) Int. Cl. G06F 17/30

(52) U.S. Cl. 707/723; 707/769; 707/E17.014

(57) ABSTRACT

A system comprising a database to store information concerning uniquely identified individuals, and a server to identify associations between the individuals and to assign rankings of the individuals based on the associations.

### CROSS-REFERENCE TO RELATED PATENT DOCUMENTS

The present application claims the benefit of priority under 35 U.S.C. Section 119(e) to U.S. Provisional Patent Application Ser. No. 61/150,615, filed on Feb. 6, 2009, and to U.S. Provisional Patent Application Ser. No. 61/295,158, filed on Jan. 14, 2010, which applications are incorporated herein by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2010, Jake Knows, Inc., All Rights Reserved.

### TECHNICAL FIELD

Example embodiments relate to discovering and determining the strength of relationships between people based on a database that links one or more attributes associated with each person, such that trustworthiness, skills, competence, or interests of a person can be determined more reliably.

### BACKGROUND

A number of technical problems exist for people and companies in validating other people's identity, skills, competence, and interests.

### BRIEF DESCRIPTION OF THE DRAWINGS

FIG. 1 is a representation of a system configuration, according to an example embodiment.

FIG. 2 is a representation of an association network, according to an example embodiment.

FIG. 3 is a representation of a type 5 association, according to an example embodiment.

FIG. 4 describes the association application, according to an example embodiment.

FIG. 5 is a representation of an association transaction, according to an example embodiment.

FIG. 6 is a representation of the person table entry, according to an example embodiment.

FIG. 7 is a representation of a contact list entry, according to an example embodiment.

FIG. 8 is a flow diagram of an indirect contact generation, according to an example embodiment.

FIG. 9 is a representation of the communications log, according to an example embodiment.

FIG. 10 is a representation of an attribute descriptor, according to an example embodiment.

FIG. 11 is a representation of a persona table, according to an example embodiment.

FIG. 12 is a flow diagram depicting how to build associations, according to an example embodiment.

FIG. 13 depicts an association matrix, according to an example embodiment.

FIG. 14 is a representation of an association, according to an example embodiment.

FIG. 15 is a flow diagram of the query transaction, according to an example embodiment.

FIG. 16 is a table representing a persona histogram, according to an example embodiment.

FIG. 17 is a table representing an attribute histogram, according to an example embodiment.

FIG. 18 is a block diagram of client architecture, according to an example embodiment.

FIG. 19 is a block diagram of a server architecture, according to an example embodiment.

FIG. 20 is a block diagram of machine in the example form of a computer system within which instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Contacts in mobile phone address books constitute non-linked micro-databases and contain partial attributes for any one contact's identity; however, they can be automatically enriched. According to an example embodiment, a system is provided to allow people to curate their own identity and to also allow discovery of identities through querying contacts and citation rankings. The basis of discovery for contact rank ordering is a declaration of the type of linkages, in the example form of associative intent, between contacts through implicit and explicit computations. Associative intent may be a reason two or more contacts have one another in their respective address books. Understanding associative intent between contacts authenticates and verifies the full identity and validity of a person. The quality of associative intent is derived from understanding the person's unique contact set and their attributes. An example embodiment enables commercial endeavors by using identity authentication and verification of people previously unknown to the endeavor, as well as providing individuals with reliable and useful information about their contacts. Enabling technologies to address these opportunities may be implemented in the personal devices (e.g., Internet-enabled cell phones, so-called smart phones, feature phones etc.) and various Internet appliances have become a personal repository for their users. These devices contain calendars, contact lists, e-mail messages, games, music, videos, Internet search histories, and so forth, most of which information describes various aspects of the user and the user's contacts. Such micro databases are conventionally used by the user for the purpose for which they were intended. However, the inclusion of user specified programming in personal devices gives the user the ability to extend the use of the information beyond the boundaries of the personal device into the information contained in other personal devices.

The contact information in personal devices may be used, according to example embodiments, as a map of the interconnections between the various personal device users, and attributes stored within the devices can be used to determine why a person is associating with another person.

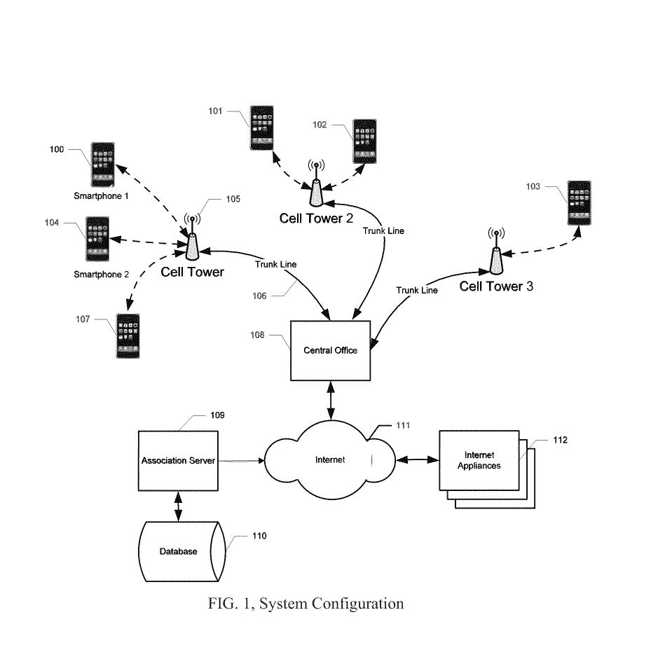

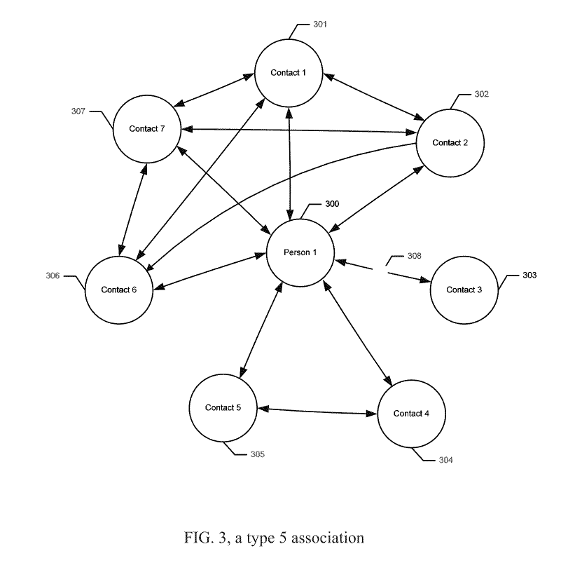

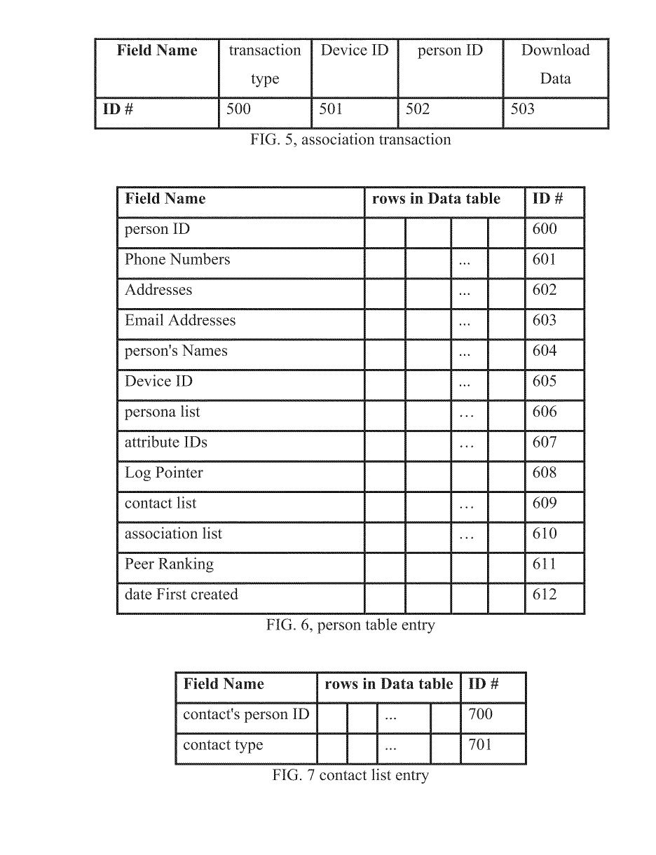

FIG. 1 is a block diagram illustrating an environment in which various example embodiments may be deployed. Elements 100, 101, 102, 103, 104, and 107 are mobile devices (e.g., smart phones and feature phones (phones)), which are connected through the various wireless networks that support communications with the devices. The phone 100 connects via a most accessible cell tower 105, via a trunk line 106 to a central office 108 using standard technology. Additionally, Internet appliances 112 are connected through the Internet 111. Each of the mobile devices and Internet appliances hosts an association application, an example of which is shown in FIG. 3. If the user has activated the association application in the phone 100 or Internet appliance 112, then the application sends an association transaction (see FIG. 5), requested by the user, from the phone 100 to the association server 109.

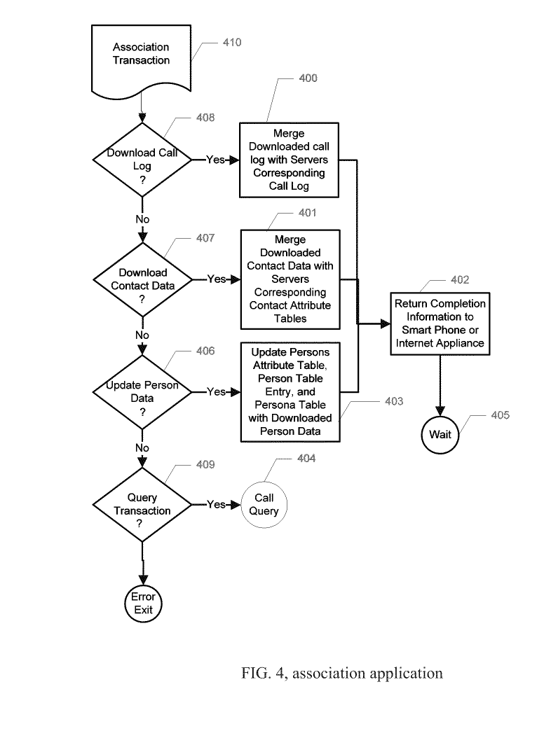

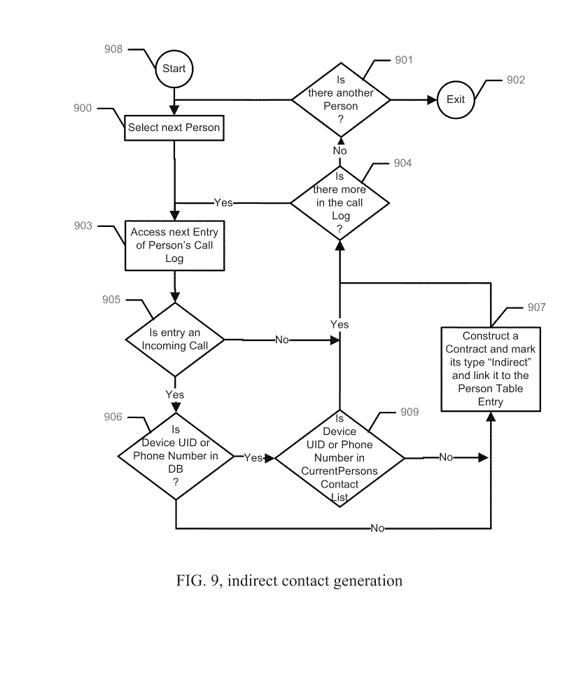

At the association server 109, an association application (see FIG. 9) processes the transaction as is shown in FIG. 4, association application, updating database 110, which contains the table entries (see FIG. 6), the contact table entries (see FIG. 7), log entries, and the metadata needed to support these. Note that this application is described in terms of the Internet, but the concepts are easily implemented on any digital networking technology.

Additionally, the association server 109 can communicate with various Internet appliances 112, such as Facebook, MySpace, Gmail, Outlook, and other Internet applications, requesting, collecting and processing the various attributes of persons and contacts. That data is formatted into an association transaction format and processed by the association application (See FIG. 4). By this mechanism, data can be acquired by the system from various sources.

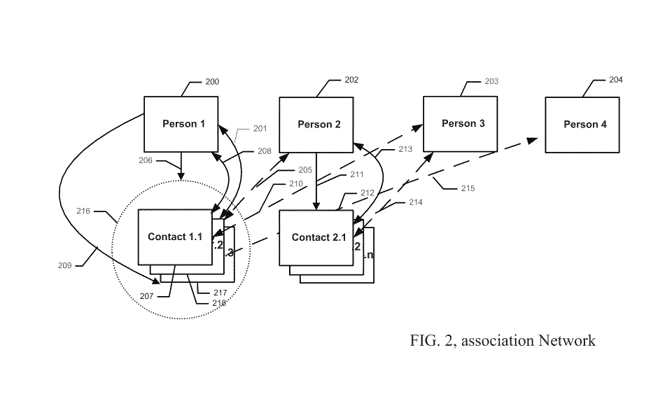

FIG. 2 is a representation of an association network, according to an example embodiment. A person has links to other people (e.g., contacts). FIG. 3 is a graphical representation of a type 5 association, according to an example embodiment, wherein people are represented by circles and the connections between them by various styles of line. Person 1 200 and its contact structure will be discussed in detail. Person 2 202, person 3 203, and person 4 204 are included to facilitate that discussion. Person 1 200 is connected by link 206 to zero or more other people which form a collection (type 1 association 216) which consists of all the persons found in the contact lists of person 1 200. Link 208 is a “strong” link, which may be characterized by person 1 200 and contact 1.1 207 both having contacts for each other in their respective contact list. This strong link is represented by a double ended arrow, and is conveniently labeled a type 2 association. Link 201 depicts a strong link which is two-way link between person 1 200 and contact 1.2 218. A strong link indicates a person is more likely to have a relationship with the contact because it implies a two-way relationship.

Link 209 indicates a “soft” link between person 1 200 and contact 1.3 217. A soft link indicates a one-way relationship, such as a bagel shop that the person calls to place orders, for example.

The next stronger level of association is, for convenience, labeled a type 3 association and is determined by the interconnections between the members in a person's contact list 609. In association 216, contact 1.1 207 is shown to be linked to person 3 203 by a strong link 210, contact 1.2 218 is shown to be linked to person 2 202 by a strong link 205, and contact 1.3 217 is shown to be linked to person 4 204 by a soft link 215. The arrows at the end of links 208, 205, 210, and 215 indicate whether the link is a soft link (single ended arrow) or a strong link (double ended arrow). The head of the arrow points to the person that does not have a reciprocating link in his/her contact list to the other person. The details of these links are stored in the FIG. 6 person table and the FIG. 7 contact list entry.

An example type 4 association is show in the link chain where link 211 indicates a strong link between person 2 202 and contact 2.1 212, who is shown to be also linked to person 3 203 by link 214. This link completes a circular chain from person 1 203 via link 210 to person 3 203, on to person 2 202 via links 213 and 214, and then back to person 1 200 via links 205 and 201.

An example type 5 association is a subset of a type 4 association, which includes all the contacts that are in a type 4 association, where every contact in the type 4 association is a contact of all the other members of the type 5 association.

The concept of “degree” is used to modify these types of associations. “Degree” may be the percentage of the links between the contacts in an association.

FIG. 3 is a diagrammatic representation of a type 5 association, according to an example embodiment. The representation of the type Five association is shown as a subset of a larger type 1 association, and consists of person 1 300, contact 1 301, contact 2 302, contact 3 303, and contact 7 307. All the links connecting these entities are strong links and each individual is connected to all the others. A type 5 association has at least two members, thus person 1 300, contact 5 305 and contact 4 304 are a type 5 association, as are person 1 and contact 3 303. As there are six links in this association (ten links minus the four links to person 1 300), if one were missing, it would have a degree of 0.8.3.

The person 1 300 to contact 3 303 link 308 is the only link of contact 3 303 and thus this subset is a type 2 association. The person 1 300, contact 5 305, and contact 4 304 are also connected with strong links but with only 3 members, this does not qualify as a type 5 association.

FIG. 4 is a flowchart illustrating operation of an association application 410, according to some example embodiments. The association application 410 may process an association transaction (see FIG. 5) as described below. The association transaction is received and examined at operation 408. If it is determined to be a “Download communications Log” operation, control is passed to operation 400, where the information in the download is merged with a database 110 (of a log in association server 109) that is associated with a person ID 502. A completions notice is then sent at operation 402 to the smart phone or Internet appliance that had submitted the transaction. The association application 410 then waits for the next transaction at operation 405.

Otherwise the transaction is examined at operation 407. If it is determined to be a “Download contact Data” transaction, control is passed to operation 401, where the information in the download is merged with a contact list entry in database 110 (of the association server 109) that is associated with person ID 502. A completions notice is sent by operation 402 to the smart phone or Internet appliance that had submitted the transaction. The association application 410 then waits for the next transaction at operation 405.

Otherwise the transaction is examined at operation 406. If it is determined to be an “Update person Data” transaction, control is passed to operation 403, where the information in the download is merged with a person table entry (see FIG. 6), in the database 110, that is associated with person ID 502. A completions notice is the sent at operation 402 to the smart phone or Internet appliance that had submitted the transaction. The association application 410 then waits for the next transaction in operation 405.

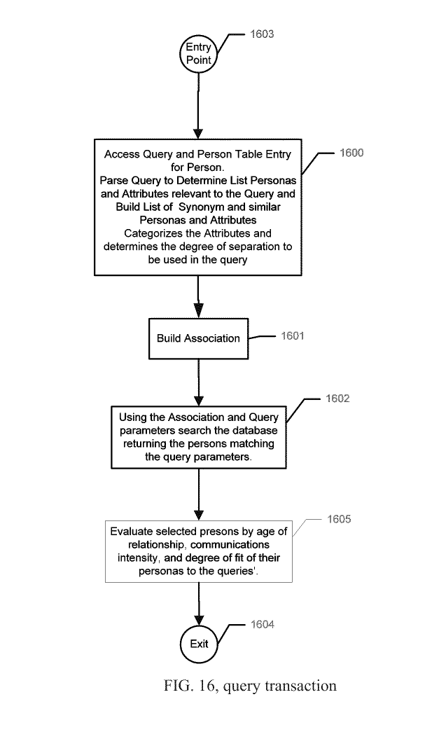

Otherwise the transaction is examined in operation 409. If it is determined to be query transaction, control is passed to operation 404 which calls query transaction (see FIG. 16). These transactions are not essential to the teaching of the present embodiment. Control is then given to operation 402, which returns the completion information to the smart Phone or Internet appliance, and enters operation 405 and waits for the next transaction.

FIG. 5 is a table showing content of association transaction, according to an example embodiment. The association transaction contains information that the smart phone or Internet appliances are sending to association application for processing. The association transaction, in some example embodiments, may include the following fields: transaction type 500, as delineated in 201, 203, 205 and 207; a device ID 501, which is used to match the device ID 605 in a person table (see FIG. 6); a person ID 502, which is used to identify the person for whom the transaction is being processed for, and download data 503, which contains the information required to execute the requested association transaction.

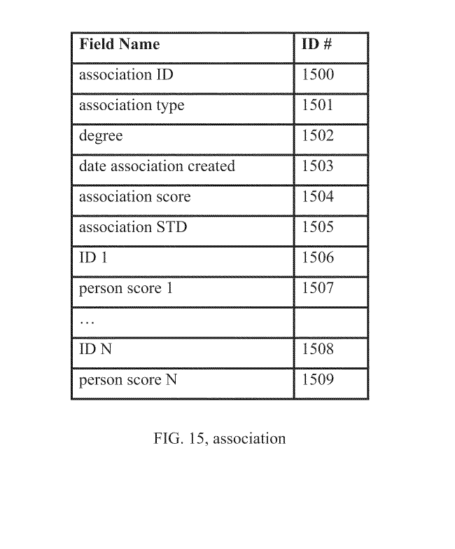

FIG. 6 is a representation of a person table entry, according to an example embodiment. A person table entry describes an individual that is either a member or a contact of the member. The table may be stored in a conventional database and can be accessed by one or more of the unique keys, such as person ID 600, phone numbers 601, email addresses 603 and device ID 605. It contains one person ID 600 that identifies the person; one or more phone numbers 601 associated with that person; one or more addresses 602, postal or street, associated with that person; one or more person's names 604 that that person uses; one or more device IDs 605, which is a unique ID for each smart phone or feature phone used by the person; a persona list 606, which describes one or more ways this person has elected to be known (e.g., the individual personas are maintained in a persona table, such as that shown in FIG. 120; attribute IDs 607, which contain a list of attribute names that apply to this person; a Log Pointer 608, which is a used to find the FIG. 9, log entries; a contact list 609, which contains a list of person IDs for all the contacts of the person; an association list 610, which contains pointers to all of the associations (see FIG. 15) for this person; a peer ranking 611, which indicates the degree to which the person's attributes agree with the attributes of the contacts in the associations; and the date first created 612, which is date the person table entry was created for this person.

FIG. 7 is table showing contents of a contact list entry, according to an example embodiment. The contact list entry contains a contact's person ID 700, which is the unique identifier of a person in a person table entry having person ID 600 that is identical to contact's person ID 700. Also in the entry is contact type 701, which indicates whether the corresponding contact is a direct or an implied contact.

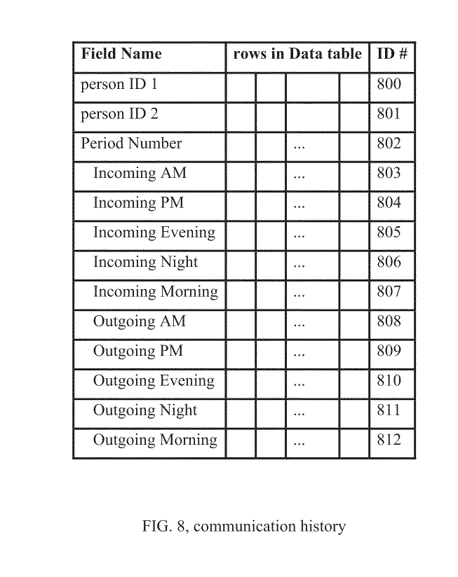

FIG. 8 is a table illustrating communication history data, according to an example embodiment. The communication history data describes the communications between a person defined by a person table entry, that person having person id 600 (which is stored in person ID 1 800) and a contact of that person having a different person id 600 (which is stored in person ID 2 801). The rest of the table contains a summary of communications activity for a plurality of periods for incoming and outgoing communications. They are described by a set of repeating fields herein described by a generic period, which is described as follows: period number 802 contains sequential integers between 1 and the number (n) of periods being tracked, where n is assigned to the most recent period and one (1) to the least recent period. incoming AM 803 gives the count of incoming calls to the person from the contact received in the morning hours, incoming PM 804 gives the count of incoming calls to the person from the contact received in the afternoon hours, incoming evening 805 gives the count of incoming calls to the person from the contact received in the evening hours, incoming night 806 gives the count of incoming calls to the person from the contact received in the morning hours, incoming morning 807 gives the count of incoming calls to the person from the contact received in the morning hours, outgoing AM 808 give the count of incoming calls to the person from the contact received in the morning hours, outgoing PM 809 give the count of incoming calls to the person from the contact received in the morning hours, outgoing evening 810 give the count of incoming calls to the person from the contact received in the morning hours, outgoing night 811 give the count of incoming calls to the person from the contact received in the morning hours, and outgoing morning 812 give the count of incoming calls to the person from the contact received in the morning hours.

FIG. 9 is a flowchart illustrating an indirect contact Generation process, according to example embodiment. The process is initiated at operation 908, which transfers control to operation 900 that selects the next person in the database to process and passes control to operation 903, which accesses the next entry in that person's log and passes control to operation 905.

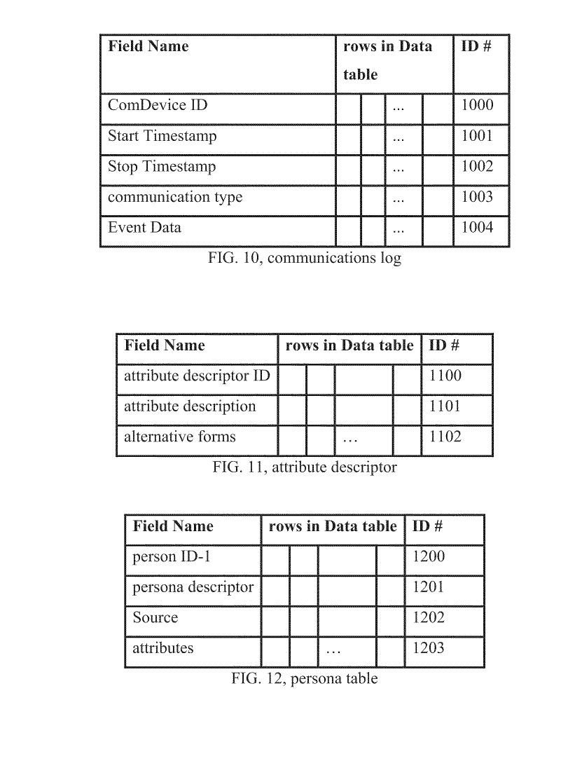

Operation 905 checks a communications log (see FIG. 10) to determine if it is for an incoming call. So control is passed to operation 906, otherwise control is passed to operation 904. Operation 906 determines if a device ID 605 is in the database 110. If so control is passed to operation 909; otherwise control is passed to operation 907. Operation 909 determines if the device ID 605 is in one of the contact table entries. If so, an entry for this device exists and the log is skipped by passing control to operation 904. Otherwise operation 907 adds a contact to the database by construction a contact table entry, marking it as “indirect” and adding an additional link in contact list 609 to point to the appropriate contact list entry. Control then is passed to operation 904. Operation 904 checks the communications log for the current person to determine if there is another communications log to process. If so control is passed to operation 903, otherwise control is passed to operation 901. Operation 901 determines if there are more persons to process. If so, control is passed to operation 900. Otherwise control is passed to operation 902 which terminates the process.

FIG. 10 is a representation of a communications log, according to an example embodiment. The communications log describes phone calls and other communications (e.g., emails, SMS, fax etc.) made and received by a person ID 600 from any of the communications devices in the person table (see FIG. 6) for the relevant person. A communications log describes all the communications made and received by a person ID 600. The fields contained in the communications log, according to an example embodiment, may include: DeviceCom ID 1000 is a unique id assigned to the phone or Internet appliance; Start Timestamp 1001 contains the date and time the communication started; Stop Timestamp 1002 contains the date and time the communication stopped; communication type 1003 indicates the type of call e.g., call out, call in, call missed, voicemail received, text, email, Facebook posting, etc; and Event Data 1004 contains any text, image, or other digital information associated with the communication.

FIG. 11 is a table representing an attribute descriptor, according to example embodiment. The attribute descriptor is composed of an attribute descriptor ID 1100, a normalized description of the attributes in the field attribute description 1101, and a list of alternative forms 1102 of the attribute description. The alternative forms 1102 is a list of attribute descriptor IDs 1100 that are synonyms for the attribute. E.g. “Pitcher” is an alternative to “Baseball Player” but not vice versa. This list is created and updated in the process of adding persons and contacts to the system and while updating the various persons and contacts information. Attribute descriptors are maintained in a separate table in the database and can be queried by various query languages including SQL.

FIG. 12 is a table representing a persona table, according to example embodiment. The persona table is used to link a person to the associated contacts. It is composed of person ID-1 1200 which identifies the Member described; a persona descriptor 1201, which describes the primary characteristics of the persona; Source 1202, which indicates if the persona was constructed by the person if it is null, or provided by a contact if it contains a person ID 600; and attributes 1203, which are one or more textual descriptions of the attributes assigned to this persona.

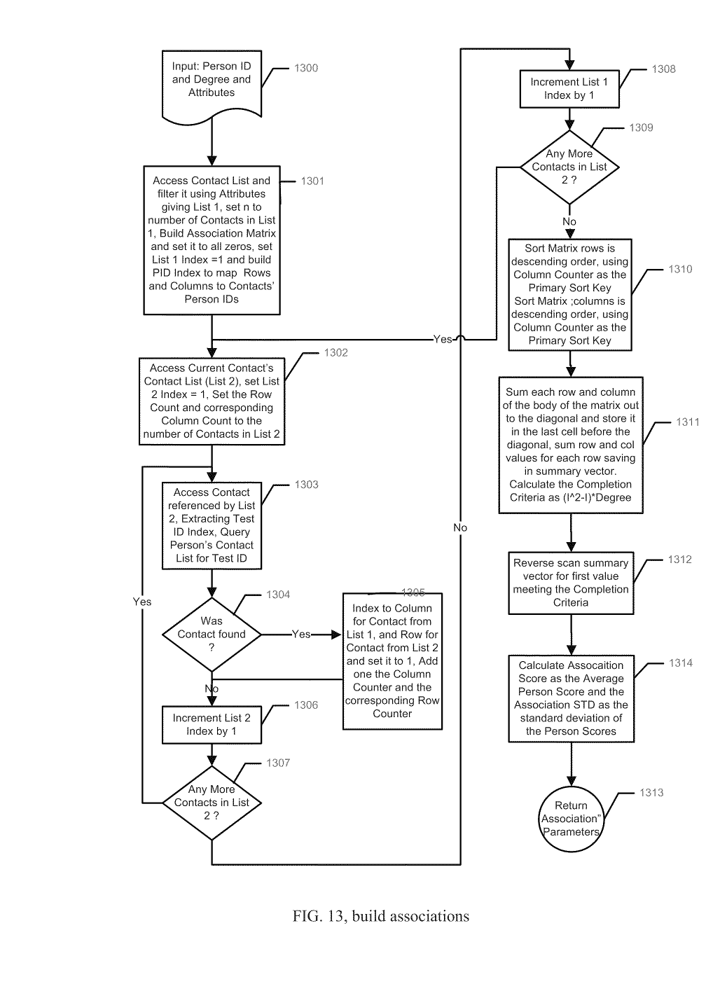

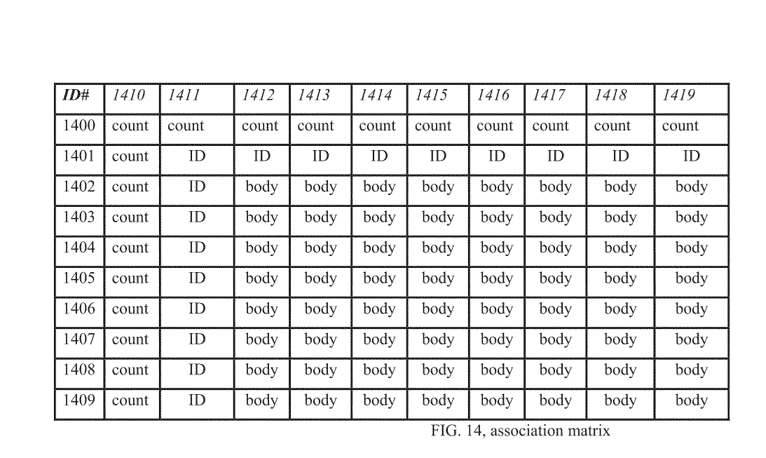

FIG. 13 is a flowchart illustrating a process to build associations, according to an example embodiment. The process start at operation 1300, which accepts the person ID 600, (see FIG. 12 persona table) and degree criteria and passes the person ID 600 to operation 1301. Operation 1301 uses the person ID 600 to access the person table entry (see FIG. 6) for that person, building a skeletal association (see FIG. 15), extracting the contact list 609, selecting the contacts with the best match to the attributes 1203 supplied in the FIG. 12 personal table, and producing a list (list 1) of those contacts, storing the degree of match into the FIG. 15 association, as person score N 1509, then counting the number of entries in that list in counter N, then it builds association matrix (see FIG. 14) with N+2 rows and columns. The elements are set to zero. Then list 1 Index is set to 1. Then the skeletal association is built assigning a unique association ID 1500 to it, recording the current date in date association created 1503.

Operation 1302 access the current contact's contact list 609, which is designated as list 2, sets the list 2 Index to 1, updates the row Count and the corresponding column Count with the number of items in list 2, then passing control to operation 1303, which extracts the contact's person ID 700 and checks to see if the person ID 700 is in the person's contact list 609. Control is then passed to operation 1304, which passes control to operation 1305 if the person ID 700 was found and to operation 1306 if the person ID 700 it was not found. Operation 1305 uses the list 1 Index to select the column and the list 2 Index to select the row in the association matrix (see FIG. 14) to set to one and the column counter for that element is incremented by one and using the list 1 Index to select the row it increments the Count for that row. It then passes control to operation 1306.

Operation 1306 increments the list 2 index by one and passes control to operation 1307, which passes control to operation 1308 if all of list 2 has been processed, otherwise control passes to operation 1303. Operation 1308 increments the list 1 Index by one and passes control to operation 1309, which passes control to operation 1310 if all of list 1 has been processed, otherwise control passes to operation 1302. Operation 1310 sorts the association matrix, treating the rows as records with the sort key being column 1303 and then re-sorts the association matrix treating the columns as records with the sort key being row 1403 (which contains the Count of ones in that row). The body of the matrix now has the largest density of ones in the upper left hand corner and the lowest density in the lower right hand corner. Control passes to operation 1311.

Operation 1311, in one example embodiment, may execute the following routine (Visual Basic Pseudocode is used):

```
Dim matrix (n, n) as string
Dim SummaryVector (n−2) as string
Dim row, column as long
Dim Sumrow, Sumcolumn as string
Dim Partialrow, Partialcolumn as string
Partialrow = 0: Partialcolumn = 0
For row = 4 to n
      Sumrow= 0: Sumcolumn = 0:
      For column = 3 to row−1
            Sumrow = Sumrow + Array (row, column)
            Sumcolumn = Sumrow+ Array (column, row)
      Next column
      Partial row = Paritalrow + Sumrow ‘ accumulate counts for rows
            Partialcolumn = Partialcolumn + Sumcolumn ‘ accumulate
counts for columns
            column = column − 1 ‘ set back to last column index
            Array (row, column) =Partialrow ‘ store results for the row
            Array (column, row) = Partialcolumn ‘ store results for
            the column
            SummaryVector (row) = Array (row, column) + Array
            (column, row)
      Next row
```

Then operation 1311 calculates the completion criteria for the search as:

CC=(î2−i)*degree/(N̂2−i),

and then passes control to operation 1312.
Operation 1312, in one example embodiment, executes the following routine (Visual Basic Pseudocode is used):

```
Dim i as long
Dim SummaryVector (n−2) as string
Dim CC as string
For i = n to 3 operation −1
      If Summary/Vector >= CC Then
            Exit For
      End If
Next i
If i<3 then
      Report Failure with 0 as the return parameter
Else  paste the
      Report Success with i as the return parameter
```

Control then passes to operation 1314, which updates the association (see FIG. 15) by generating a unique association ID 1500, setting the association type 1501 to “5” and degree to the degree calculate in operation 1312, setting the date association created 1503 to the current date, and entering the person IDs 600 of the contacts into the various ID N 1508. and the corresponding person score N 1509, that was calculated as part of the filtering process in operation 1301, then the average and standard deviation of the person score Ns 1509 are stored in association score 1504 and association STD 1505 respectively, it then sets up completion or failure parameters and passes control to operation 1313, which sends the return parameters and surrenders control to the invoking process.

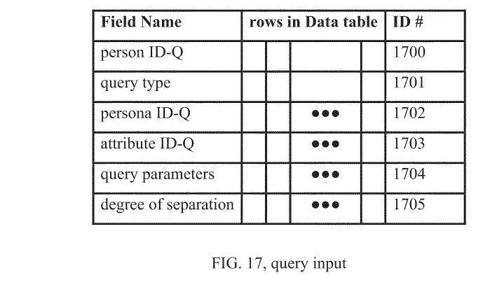

FIG. 14 is a diagram showing an association matrix 1401, according to an example embodiment. The association matrix 1401 is used in the build associations process 1300. The matrix 1401 initially contains potential associations and is modified by the build associations process 1300 to expose the largest type 5 association of the specified degree. The matrix 1401 has dimensions equal to the number of contacts in the person's contact list 609, plus one for a row and column of counters. In the example embodiment, the association matrix 14010 is shown for nine contacts, giving ten rows and columns. The matrix 1401 is composed of row 1400 which contains the column counters and column 1410, which contains the row counters. Row 1401 and column 1411 contain the contact's person IDs 700 associated with the row or column. Columns 1412 through column 1419 are mapped in correspondence to the entries in the person's filtered contact list 609. The filtering select the contacts that meet the criteria specified as in, but not exclusively by, a query input (see FIG. 17). Row 1402s through row 1409 are mapped in the same manner. Row 1402, column 1412 through row 1409, column 1419 constitutes the body of the matrix. The intersection of row n and column m contains a zero if the contact associated with column m does not have the contact associated with row n in his contact list 609. If there is a contact then the value is set to one. The matrix 1401 is used in the build association process (see FIG. 13), to find the association meeting the criteria.

FIG. 15 is a table representing of an association data, according to an example embodiment. The association data may be a list of the person IDs 600 and contact's person IDs 700 that form an association. It is composed of a unique association ID 1500; an association type 1501; the degree 1502 determined when building the association, date association created 1503, which is the date that the association 1501 was created; an association score 1504, which is average the person score N 1509 in the association; an association STD 1505, which is the standard deviation of all the person scores N 1509, and a plurality of IDs represented by ID 1 1506 through ID N 1508 (ID N 1508 is used as the generic representation of these IDs). These IDs are paired with a person score 1 1507, through person score N 1509, which are the percent of the attributes of the person's attribute IDs 607 that are matched by the person with ID N 1206's attributes. Person score N 1509 may be used as the generic representation of these IDs.

FIG. 16 is a flow diagram illustrating a query transaction process 1620, according to an example embodiment. The query transaction process 1620 begins at operation 1603, which is the entry point to the process. Control passes to operation 1600, which access the query, determines the person ID and access the person table entry for that person. The process 1620 then parses the query to determine which attributes are relevant to the query, and categorizes the attributes and determines for each the degree of separation that is to be use. Control then passes to operation 1601, which builds an association using the union of the attributes specified by the persona ID-Q 1702 and attribute ID-Q 1703 lists, and the attributes found in the query parameters 1704 list. Control then passes to operation 1602 and a query is performed using the association and all contacts linked to the association within the limits of the degree of separation 1705, this returns a list of persons that meet the query criteria then control passes to operation 1604, which use the current data and the date first created 612 from each person table entry (FIG. 6) belonging to each of the persons returned by the query to calculated the duration of association (DOA) between the querier and each of the persons, compares the attribute IDs 607 list of the querier and each of the persons returned by the query to calculate a degree of fit (DOF) for each person, which is the percent of the querier's attributes that the person has, and access the communication history (FIG. 8) for the querier (person ID 1 800) and each of the persons returned by the query (person ID 2 801) and calculates the communications intensity by summing the incoming calls (SumIn) and summing the outgoing calls (SumOut) in the FIG. 8 communication history and then calculating communication intensity as, for example,:

CI=C₁*SumIn+C₂*SumOut

where C₁ and C₂ are weighting constants. The three factors are combined to give a weight for each person as follows:

weight=C₃*DOA+C₄*DOF+C₅*CI

where C₃, C₄, and C₅ are weighting constants. Then the persons are ordered from highest to lowest weight and the results are returned to the querier then control passes to operation 1605, exiting the process.

FIG. 17 is a table illustrating a data structure describing a query input 1720, according to example embodiment. The query input 1720 is a table generated from a user interface and is composed of: person ID-Q 1700, which is an instance of a person ID 600 that identifies the person making the query; query type 1701 which specifies what kind of query is being performed. The types may include, for example, find association, find person, find skill, and find interest, etc, having a confidence level 1701a that the information or person retrieved is reliable. Persona ID-Q 1702 is an list of zero or more persona IDs 1200 that are owned by person ID-Q 1700, and have been specified by that person as filters to be used in the query; attribute ID-Q 1703 is an list of zero or more attribute IDs 1100 that have been specified by that person as filters to be used in the query. These are in addition to the attributes that are associated with the personas specified in persona ID-Q 1702. query parameters 1704 is a list of one or more parameters that further defined the query. Say a person wishes to find a carpenter to fix his vacation home in Aspen, then query type 1701 would specify “person Search” and the query parameters would contain terms like “Carpenter”, “Aspen, CO”, etc. Degree of separation 1705 defines how many links should be included in the query. A degree of separation of 2 indicates that just contacts and their contacts should be searched. A degree of separation of 1 indicates that just contacts should be searched A query trying to find a friend that bowls would use a degree of separation of 1, whereas if the query was trying to find a carpenter a value of 2 or more would be appropriate.

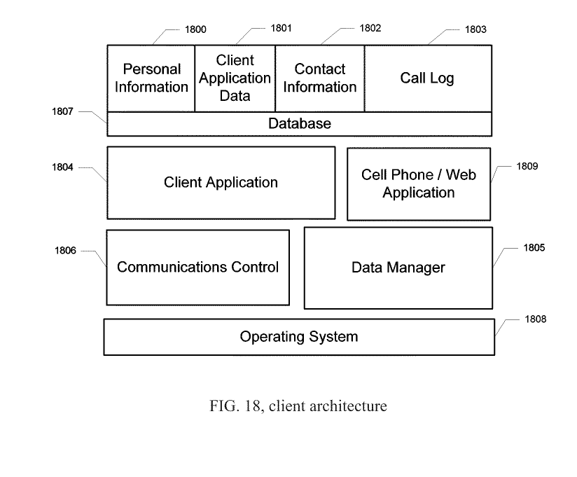

FIG. 18 is a block diagram depicting a client architecture, according to an example embodiment. The client architecture is composed of an operating system 1808 which is provided by manufacturer of the devices be it smart phones 100 or Internet appliances 112. The operating system provides the base hardware control mechanism. The services communications control 1806, database 1807, and data manager are built on the operating system's services. Communications control 1806 is the interface from the client to the communications network used. In the case of the cell phone based systems, the network may include the common carriers network, represented by trunk line 106 and central office 108, linked to the Internet. For the Internet appliances 112, the network is the Internet 111. Communications control 1806 is interfaced with client application 1804 and act as the port for the client application's 1804 communications with the association server 109. The data manager 1805 controls the physical storage in the client and controls access, security, space management for the client application 1804, cell phone/web application 1809, and database 1807. The client application 1804 provides the user interface to the various services provided by the associative server. The cell phone/web application 1809 is provided by the cell phone vendor and provides the cell phone services to the user. database 1807 manages the information in the various databases of personal information 1800, client application data 18021, contact information 1802 and the call log 1803, and provides the query and update services for these data. Personal information 1800 contains information about the user. It has been extended by the client application 1804 to include information required to support the association server 109 applications. Client application data 18021 contains the new data structures required to support the client application 1804. Contact information 1802 supports the cell phone/web application contact list features. It is augmented by the client application 1804 to support the requirements of the association server 109 applications. Call log 1803 is provided by the cell phone/web application and contains information about the user's contacts. It is accessed by the client application 1804 to support the requirements of the association server 109 applications necessary to build and use FIG. 15 association.

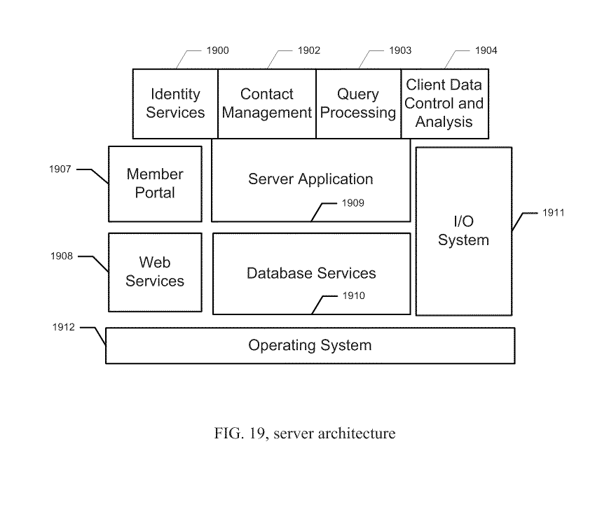

FIG. 19 is a block diagram depicting server architecture, according to an example embodiment. the association server 109 software architecture includes a conventional operating system 1912 like IBM'S Z/OS, LINUX, UNIX, and MICROSOFT WINDOWS 7 among others. On top of that base is an I/O system 1911 which provides for the software to manage all I/O devices including disk storage and communications hardware. It is used by all the components of the system for these services. Database services 1910 provide the repository for the server application 1909 data structures. These may be stored in a variety of forms including flat files, relational, hierarchical, and object databases. Web services 1908 provides the protocols and controls necessary to attach to the Internet 111. It is used by server application 1909 to communicate with the various client machines. Member portal 1907 receives messages from the clients from the web service 1908 and passes them to the server application 1909 which executes the various processes described herein. The server application is further subdivided into the functions including: identity services 1901 (registration, login, verification), contact management 1902 (discovery, validation, association analysis), query processing 1903, and client data control and analysis 1904.

The structure and arrangement of the components of FIG. 2 server architecture is one of a number of implementation that one skilled in the state-of-the-art could design.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

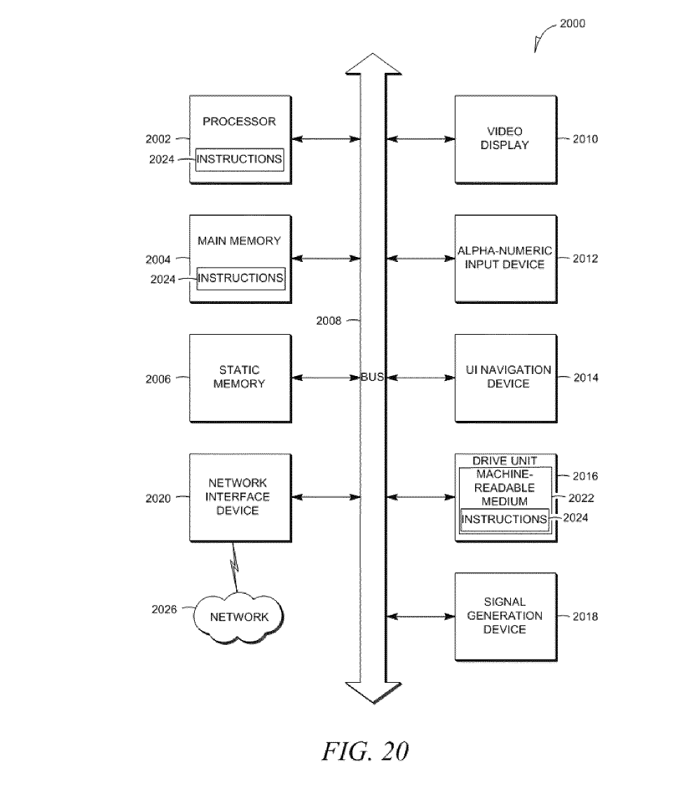

FIG. 20 is a block diagram of machine in the example form of a computer system 2000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor 2002 (e.g., a central processing unit (CPU), a graphics processing unit (GPU) or both), a main memory 2004 and a static memory 2006, which communicate with each other via a bus 2008. The computer system 2000 may further include a video display unit 2010 (e.g., a liquid crystal display (LCD) or a cathode ray tube (CRT)). The computer system 2000 also includes an alphanumeric input device 2012 (e.g., a keyboard), a user interface (UI) navigation device 2014 (e.g., a mouse), a disk drive unit 2016, a signal generation device 2018 (e.g., a speaker) and a network interface device 2020.

### Machine-Readable Medium

The disk drive unit 2016 includes a machine-readable medium 2022 on which is stored one or more sets of instructions and data structures (e.g., software) 2024 embodying or utilized by any one or more of the methodologies or functions described herein. The instructions 2024 may also reside, completely or at least partially, within the main memory 2004 and/or within the processor 2002 during execution thereof by the computer system 2000, the main memory 2004 and the processor 2002 also constituting machine-readable media.

While the machine-readable medium 2022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 2024 may further be transmitted or received over a communications network 2026 using a transmission medium. The instructions 2024 may be transmitted using the network interface device 2020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a database storing information concerning uniquely identified individuals; and
a server to identify associations between the individuals, and to assign rankings of the individuals based on the associations.

2. The system of claim 1, wherein the database stores association information including a type of association, a frequency and direction of usage of the association, a time of usage of the association, the server to estimate a kind and strength of the association between two or more individuals.

3. The system of claim 2, wherein identifying information and attributes of the uniquely identified individuals are maintained in the database and the server is to refine the estimate of the kind and strength of the relationship between two or more individuals using the identifying information and attributes of the uniquely identified individuals.

4. The system of claim 1, wherein the database is to store:
association information including a type of association, a frequency and direction of usage of the association, and a time of usage of the association, and
identifying information and attributes of the individuals, and
the server is to estimate a reliability of a first individual with respect to a second individual using the association information and the identifying information and attributes in the database.

5. The system of claim 1, wherein the server is to discover associations between individuals based on contact lists.

6. The system of claim 1, wherein the server is to discover associations between individuals based on communications logs.

7. A system comprising:
database means to store information concerning uniquely identified individuals and associations between the individuals, and
means to find associations of individuals that meet connectivity requirements.

8. The system of claim 7, comprising means to assign metrics to the associations based on a number and strength of links defining the association.

9. The system of claim 7, wherein the database means is to store a type of an association, a frequency and direction of usage of the association, and a time of usage of the association to estimate a kind and strength of the relationship between two or more individuals who are members of the association.

10. The system of claim 9, wherein the database means is to store identifying information and attributes of the individuals, the system further comprising means to refine the estimate of the kind and strength of the associations between two or more individuals.

11. The system of claim 9, comprising process means to discover associations between individuals based on contact lists.

12. The system of claim 9, comprising process means to discover associations between individuals based on communications logs.

13. A method comprising:
storing information concerning uniquely identified individuals in a database; and
identify associations between the individuals, using a processor;
assign rankings of the individuals based on the associations, using the processor.

14. The method of claim 13, comprising:
storing association information including a type of association, a frequency and direction of usage of the association, a time of usage of the association; and
estimating a kind and strength of the association between two or more individuals.

15. The method of claim 14, comprising:
storing identifying information and attributes of the uniquely identified individuals in the database; and
refining the estimate of the kind and strength of the relationship between the two or more individuals using the identifying information and attributes of the uniquely identified individuals.

16. The method of claim 14, comprising storing, in the database:
association information including a type of association, a frequency and direction of usage of the association, and a time of usage of the association, and
identifying information and attributes of the individuals, and
estimating a reliability of a first individual with respect to a second individual using the association information and the identifying information and attributes in the database.

17. The method of claim 14, comprising discovering associations between individuals based on contact lists.

18. The method of claim 14, comprising discovering associations between individuals based on communications logs.

19. A method comprising:
storing, in a database, information concerning uniquely identified individuals and associations between the individuals, and
identifying, using a processor, associations of individuals that meet connectivity requirements.

20. The method of claim 19, comprising assigning metrics to the associations based on a number and strength of links defining the association.

21. The method of claim 20, comprising using a type of an association, a frequency and direction of usage of the association, and a time of usage of the association to estimate a kind and strength of the relationship between two or more individuals who are members of the association.

22. The method of claim 21, comprising storing identifying information and attributes of the individuals, and refining the estimate of the kind and strength of the associations between two or more individuals.
